(19) United States
(12) Patent Application Publication
(10) Pub. No.: US 2014/0065876 A1
(43) Pub. Date: Mar. 6, 2014

(54) METHOD AND APPARATUS OF MANUFACTURING A CABLE ASSEMBLY

(71) Applicants: Jan Van Tilburg, GJ Oss (NL); Wilfred Vermeulen, EL Heeswijk-Dinther (NL)

(72) Inventors: Jan Van Tilburg, GJ Oss (NL); Wilfred Vermeulen, EL Heeswijk-Dinther (NL)

(21) Appl. No.: 13/994,059

(22) PCT Filed: Dec. 8, 2011
(86) PCT No.: PCT/EP2011/072168

§ 371 Date: Nov. 18, 2013

(30) Foreign Application Priority Data
Dec. 14, 2010 (EP) 10194995.6

(51) Int. Cl. H01R 43/20; H01R 31/00

(52) U.S. Cl. CPC H01R 43/20; H01R 31/00
USPC 439/502; 29/857

(57) ABSTRACT

The present invention relates to a method of manufacturing a cable assembly, an apparatus for the manufacture of a cable assembly, as well as a preassembled cable assembly comprising a cable having at least two cable wires running inside a cable jacket, and at least one connector arranged at each end of the cable. For an improved method and apparatus providing a simplified supply chain and with an increased flexibility and short lead times, the present invention provides a method of manufacturing a cable assembly comprising the steps of connecting at least one end of cable wires with terminal elements, and thereafter providing a cable jacket around the cable wires and an apparatus for the manufacture of a cable assembly, comprising a termination unit for connecting an end of a cable wire with a terminal element and a jacketing unit for providing a cable jacket around cable wires. The preassembled cable assembly of the present invention comprises a cable jacket that is manufactured in a predetermined length (L₃₇) around the cable wires.

The present invention relates to a method of manufacturing a cable assembly, an apparatus for the manufacture of a cable assembly, as well a preassembled cable assembly comprising a cable having at least two cable wires running inside a cable jacket, and at least one connector arranged at each end of the cable.

A cable assembly comprises a cable having at least two cable wires inside a cable jacket, and at least one connector at each end of the cable. In current methods for manufacturing a cable assembly, the cable is produced separately and independent from the connectors. The semi-finished products, a reel of cable and the connectors, are then shipped to the production facility where the connectors are connected to the cable for producing the cable assembly. To make a cable suitable for connection or termination with the connector, the cable has to be cut to the right length, the cable wires need to be prepared by removing the jacket, shielding and so on, and the lead of each wire has to be laid open. Thereafter, the individual wires have to be sorted and arranged according to a colour coding for identifying the respective cables, e.g. in a USB or a micro USB cable, the data lines, the power lines, the ground and the drain wire, before terminating the ends of each of these cables with the corresponding terminal element of the connector. This cable preparation process creates a lot of waste and makes several additional steps necessary during the manufacturing process of a cable assembly.

Furthermore, the independent production of the semi-finished connectors and the cable make a cumbersome and complex supply chain necessarily leading to long lead times and a limited flexibility during the manufacturing of cable assemblies.

In view of the above, the object of the present invention is to provide an improved method and an apparatus for manufacturing a cable assembly that has a simplified supply chain with an increased flexibility and short lead times.

The method of manufacturing a cable assembly solves this technical problem by comprising the steps of connecting at least one end of cable wires with terminal elements, and thereafter providing a cable jacket around the cable wires.

The apparatus for the manufacture of a cable assembly according to the present invention solves the problem by comprising a termination unit for connecting an end of a cable wire with a terminal element and a jacketing unit for providing a cable jacket around cable wires.

The preassembled cable assembly, which is preferably produced according to the manufacturing method of the present invention, is characterized in that the cable jacket is manufactured in a predetermined length around the cable wires.

A terminal element in the sense of the present invention refers to the part which forms the portion to which a wire is to be contacted. Preferred examples of a terminal element are a terminal contact, a printed circuit board, a conductive foil and similar devices to which a wire can be contacted. A terminal element can therefore be any device which can be connected with a wire in the sense of the present invention.

These solutions of the present invention simplify the manufacturing of cable assemblies by producing and building up the cable during the manufacturing of the cable assembly, that is bringing together the cable production, the connector production and the termination of the cables with the connectors in a single method. Thus, according to the present invention, one avoids production of an entire cable first, to then isolate or strip and arrange the wires of the cable in order to terminate them to the corresponding terminal element, such as a terminal contact of a connector. This simplifies the termination and less waste is produced, since no cable preparation, e.g. stripping, wire organizing, jacket removal, etc. is necessary. Moreover, according to the present invention, there is no need to produce cable and connectors separately and ship them to the final production location, where they are made, which is less inventory on semi-finished goods as well as improves lead times and flexibility of the manufacturing of cable assemblies. This has not only an economical, but also an environmental impact, since shipping the semi-finished goods necessary for manufacturing a cable assembly according to the current methods becomes redundant. Furthermore, the logistics of the manufacturing method are improved since only the raw materials for the cable assembly need to be provided, while the manufacturing of the whole cable assembly is carried out in one location only.

The solution according to the invention may be combined in any way with the following advantageous embodiments of the present invention respectively and further improved.

According to a first embodiment of the manufacturing method of the present invention, both ends of the cable wires are connected with terminal elements before providing the cable jacket. Since the cable wires are terminated at a very early manufacturing stage, preferably in the initial stage of the manufacturing method, the identification of the individual wires, e.g. by colour coding, becomes unnecessary, not to speak of the organization of the individual wires that has to be performed in the current manufacturing methods, which becomes unnecessary and can be omitted.

According to another further possible embodiment of the manufacturing method, the cable wires can be bundled, twisted, braided and/or shielded before providing the jacket so that an arbitrary electrical cable type can be produced within the manufacturing method of the present invention.

In a further embodiment, a foil can be provided around the cable wires for bundling the cable wires in one process step. Alternatively, a laminated foil can be provided around the cable wires for simultaneously bundling and shielding the cable wires in one process step. The laminated foil, like the cable jacket, can for example be wrapped over the cable wires. Overmolding the cable is a possible alternative.

In a further embodiment of the method according to the present invention, at least two of the cable wires can be twisted, if required, before connecting both ends of the twisted wires to the corresponding terminal elements. For example, one end of two cable wires are connected with a corresponding terminal element first. Thereafter, the two wires are twisted forming a twisted pair of cables running parallel to each other that are twisted around each other in the form of intertwined helices for cancelling out electromagnetic interference from other sources and avoiding cross-talk between neighbouring wires. Finally, the other end of the intertwined cable wires can be connected with the corresponding further terminal elements.

According to another possible embodiment of the method according to the present invention, at least one end, preferably both ends of the cable wires are connected with a terminal array having a plurality of terminal elements. Thereby, one end of each cable wire may be terminated either sequentially or simultaneously with the same terminal array. Since the terminal array has a plurality of terminal elements arranged in a predefined termination pattern, each of the cable wires can be easily identified even after subsequent method steps, e.g. after twisting, braiding, bundling, shielding and jacketing the cable wires by their respective position on the terminal array. Thereby, a colour codification of the individual cable wires is not necessary anymore.

In a further embodiment, the terminal array may comprise a plurality of interconnected terminal elements, at least those of which that have been connected with a cable wire, are separated from each other and from the remainder of the terminal array. The separation can be preferably done after the jacket is provided. For example, the terminal array may be designed as a contact/terminal frame or strip made from a punched-out material, wherein the individual terminal elements are stamped terminal contacts made from strip or plate material. The interconnection between adjacent terminal elements of the array can easily be interrupted for separating the individual terminal contacts from each other. This separation is preferably done shortly or immediately before bringing the terminal elements into the final shape and arranging them in the connector housing. Alternatively terminal contacts can be separated from the carrier strip immediately after connecting the wire to the terminal element.

The end of the cable wire may be connected with the terminal elements for example by crimping or soldering the wires with the terminal elements. Alternatively, the cable wires can be connected with the terminal elements by an insulation-displacement connection (IDC). IDC has the advantage that an isolation of the lead wire has not to be striped during the cable preparation because this is done during the IDC.

According to a further embodiment of the manufacturing method of the present invention, that is particularly suited for automating the step of connecting the cable wires with the terminal elements, and hence for the automation of the manufacturing of a cable assembly, at least one, preferably all cable wires are connected to a terminal element by arranging a connecting portion of a wire substantially parallel to an entering surface of a contact opening of the terminal element, and contacting a joining section of the connecting portion with the contact opening by plastically deforming a lateral cut of the joining section.

The step of contacting the joining section of the connecting portion with the contact opening is preferably achieved by a pressing step, i.e. by pressing the wire into the contact opening. However, any deforming step suitable to achieve the plastic deformation may be used according to this embodiment.

Such a terminal assembly, i.e. a terminal element that is mechanically and electrically connected with a cable wire, is easy to manufacture automatically and results in a reliably connected terminal assembly comprising a terminal element having at least one contact opening, and at least one electric wire that is mechanically and electrically connected to the contact opening, wherein a connecting portion of the electric wire that is located outside the contact opening runs substantially parallel to an entrance surface of the contact opening, and wherein a joining section of the connecting portion is plastically deformed into and thereby non-positively connected to the contact opening.

By arranging the wire parallel with the contact opening and then connecting a portion of the wire, namely the joining section with the contact opening, e.g. by pressing the joining section into the contact opening, a mechanically and electrically secure connection can be provided between the wire and the terminal element, namely between the joining section of the wire and the contact opening of the terminal element. This way of providing a secure connection is easy to automate and good to control. The plastic deformation of the joining section provides for a reliable non-positive connection with the contact opening. No specific design of the terminal element is required for the connection since the joining section of the wire is plastically deformed. Hence, a simple terminal element can be provided at low cost because no special connecting elements are necessary. Finally, stacking various wires at a low pitch on one terminal element or a terminal array is possible, because the pitch is only limited by the distance at which adjacent contact openings can be produced in the terminal element or array.

In a further embodiment of the above terminal assembly, the contact opening can be elongated in the direction of the electrical wire. In the method step of mechanically and electrically connecting the cable wires to the terminal element, the connecting portion of the wire can be arranged substantially parallel to the entrance surface of the contact opening and also parallel to the longitudinal direction of the contact opening prior to contacting. Upon contacting, the joining section of the connection portion, that is the part of the connection portion that is in alignment with the elongated contact opening is increased. Thereby the contact area between the joining section and the contact opening can be increased. This improves the non-positive connection between the wire and the terminal element.

To further improve the connection between the wire and the terminal element, in a further embodiment, the contact opening can be provided with at least one undercut. The undercut can be designed as at least one protrusion protruding into the contact opening and/or at least one cavity forming a dent widening the contact opening. In providing the contact opening of the terminal element with an undercut, the joining section of the wire can be plastically deformed into a form fit connection with the undercut. This further improves the mechanical and electrical connection of the wire with the terminal element. The undercut may be arranged in the direction that is parallel to the entrance surface of the contact opening. Thereby a positive joint against displacing the joining section relative to the contact opening in the plane of the surface entrance can be formed. Alternatively and/or additionally, the undercut may be in the direction perpendicular to the entrance surface securing the joining section in the contact opening against moving the joining section out of the contact opening.

In a further embodiment, the elongated contact opening can be designed as a channel or groove having a substantially rectangular surface entrance. A channel or groove can be easily aligned with the joining section of the electrical wire. Also, such channel can be easily designed with an undercut, for example a channel having protrusions extending from the side walls of the channel into the channel or a groove having indentations that section-wise widen the channel. An undercut that is formed in the direction perpendicular to the surface entrance can be formed by, e.g. widening the channel in the direction from the entrance opening to the bottom, e.g. in the form of a dovetail.

In further embodiment, the contact opening may be formed as a through-hole extending from the entrance surface on one side of the terminal element to an exit surface on another side of the terminal element. For example, an elongated contact opening may thus form an aperture in the form of a slot. Such aperture or through-hole is easy to manufacture, e.g. by punching, because one does not have to take care of the depth of the opening.

Furthermore, a through-hole can improve the non-positive or force-fit connection with an additional form-fit or positive joint since the joining section, that is made of a malleable material deformed upon contacting, can be plastically deformed such that the joining section extends through the through-hole and is formed into a stopper overlaying the entrance surface and the exit surface on both sides of the terminal element. The stopper can be arranged outside the surface opening adjacent to the entrance surface and can be designed such that it extends at least section-wise over the entrance surface. Thereby the stopper can be brought into abutment with the portion of the terminal element surrounding the contact opening in the direction perpendicular to the entrance surface and the exit surface. This can be easily achieved when, during contacting, the joining section outside the contact opening is deformed as overlaying the entrance surface. The stopper may be formed for example by widening a portion of the joining section that remains outside the contact opening. The widening may be performed for example by flattening the joining section in the form of a rivet head, forming a flaring, a flange or bulge extending over the circumference of the entrance/exit surface.

In another embodiment, the volume of the wire in the joining section is greater than the volume of the contact opening. When contacting, e.g. pressing the joining section into the contact opening, the joining section substantially fills up the contact opening. Thereby, the contact area of the force-fit connection is maximized as the entire part of the joining section that is in parallel with the contact opening can be plastically deformed into the contact opening.

In a further embodiment of the connecting step, the joining section may be pressed into the contact opening in an insertion direction that runs substantially perpendicular to the entrance surface of the contact opening. Thereby, the strain applied to the terminal element in the area of the contact opening can be reduced and most of the pressure applied during contacting can be transformed into the plastic deformation of the malleable joining section of the wire. For an embodiment having an aperture or through-hole, the joining section can be plastically deformed by pressing it in the insertion direction into the contact opening, filling up the contact opening and flattening or widening the portion of the joining section swelling out of the exit opening and the portion of the joining section that remained outside the entrance of the contact opening into stoppers overlaying the entrance and the exit surface. In this way a form-fit can be provided at the entrance and at the exit of the through-hole.

The wires that are connected to the terminal element can be a solid wire, a stranded wire or a magnet wire.

As far as the volume of the joining section is greater than the volume of the contact opening, an arbitrary wire can be used in the above described embodiments for connecting an end of the cable wire to the terminal element. Even flat wires with the necessary volume may be used. Excluded are only flat wires whose cross sectional diameter is too small, that is, wires that do not provide sufficient material to allow plastic deformation to fix the wire into the contact opening.

When using a magnet wire or a wire having an insulation coating surrounding the lead or conductor of the wire, the insulation coating of the wire can be removed in the joining section during contacting the joining section with the contact opening in a further embodiment. The removal of the insulation coating may be achieved, e.g. by designing the entrance opening such that the insulation coating is scraped off the lead upon the plastic deformation. Such scraping off is for example automatically achieved when the width of the lead or the conductor of the wire in the joining section is smaller than the width of the entrance surface.

The apparatus for the manufacture of a cable assembly according to the present invention is specifically designed for carrying out the manufacturing method of the present invention.

The termination unit may comprise a deformation tool or unit, such as a tool having a first deformation element, e.g. a die for pressing the joining section of a wire in the insertion direction into the contact opening and a second deformation element, e.g. a further die or anvil that is arranged at the exit of the contact opening. The apparatus may also have a crimping unit for crimping terminal to wire, soldering unit for soldering terminal to wire, a (laser) welding unit for welding the terminal to wire, or any other device or organ that is adapted to connect a cable with a terminal element.

The jacketing unit may comprise a wrapping unit for wrapping a jacket around cable and/or a molding unit for molding a jacket over cable.

According to an embodiment the apparatus may further comprise at least one one of a twisting unit for twisting at least two cable wires, a braiding unit for braiding the cable wires, a bundling unit for bundling at least two, preferably all of the cable wires, a shielding unit for providing a shielding around at least two cable wires and/or all cable wires, a terminal insertion unit for placing the terminal elements into a housing of a connector, a molding unit for over molding cable and/or connector, and a connector assembly unit for assembling the connector.

The present invention further relates to a preassembled cable assembly that is preferably produced according to the method of manufacturing a cable assembly according to the present invention.

In a preferred embodiment of the cable assembly according to the present invention, the cable assembly comprises at least one terminal assembly comprising a terminal element, and at least one electric wire that is mechanically and electrically connected to the contact.

In a further preferred embodiment of the cable assembly according to the present invention, the cable assembly comprises at least one terminal assembly comprising a terminal element having at least one contact opening, and at least one electric wire that is mechanically and electrically connected to the contact opening, wherein a connecting portion of the electric wire that is located outside the contact opening runs substantially parallel to an entrance surface of the contact opening, and wherein a joining section of the connecting portion is plastically deformed into and thereby non-positively connected to the contact opening.

The cable assembly according to a further embodiment may comprise a terminal assembly, wherein the contact or the contact opening is elongated in the direction of the electrical wire.

The cable assembly according to a further embodiment may comprise a terminal assembly, wherein the contact opening is provided with at least one undercut.

The cable assembly according to a further embodiment may comprise a terminal assembly, wherein the contact opening is formed by a through-hole extending from the entrance surface on one side of the terminal element to an exit surface on another side of the terminal element.

The cable assembly according to a further embodiment may comprise a terminal assembly, wherein the joining section extends through the through-hole and is provided with a stopper overlaying the entrance surface at the upper side and a further stopper overlaying the exit surface on the lower side of the terminal element.

The cable assembly according to a further embodiment may comprise a terminal assembly, wherein the wire is a solid wire, a magnet wire or a stranded wire.

The cable assembly according to a further embodiment may comprise a terminal assembly, wherein the volume of the wire in the joining section is greater than the volume of the contact opening.

The invention is described hereafter by means of examples referring to exemplary embodiments with reference to the drawings. The various features of the described embodiments can be combined or omitted independently of one another, as already described above.

In the drawings:

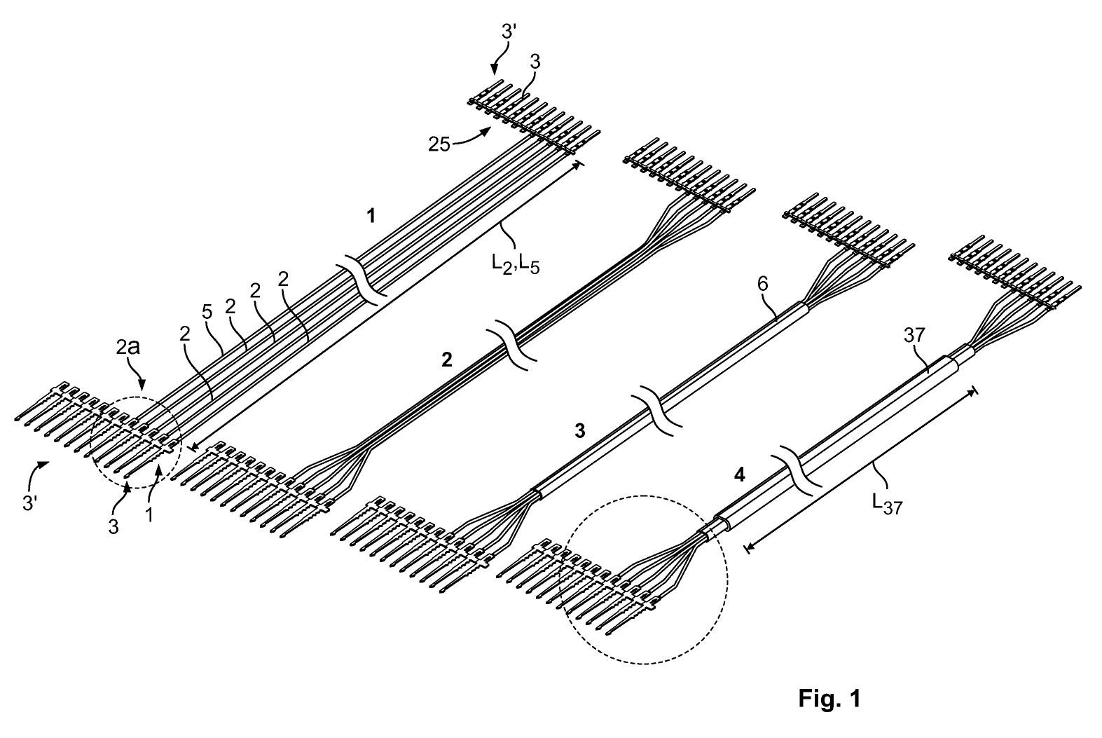

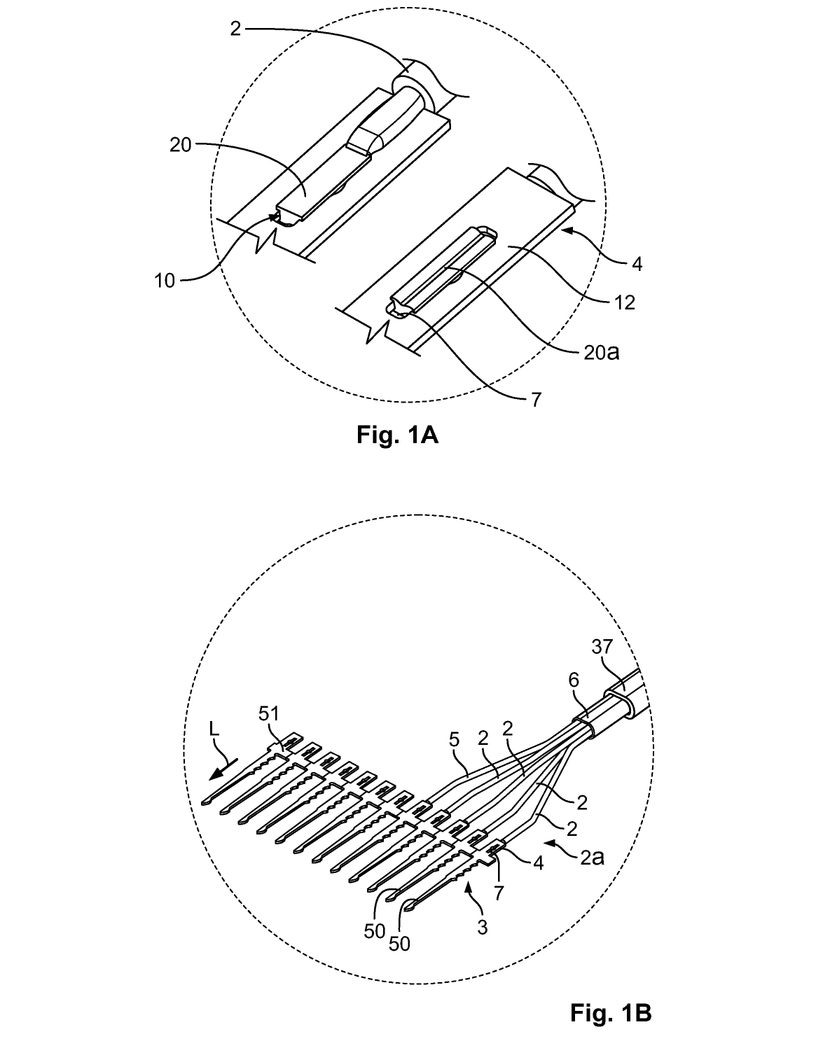

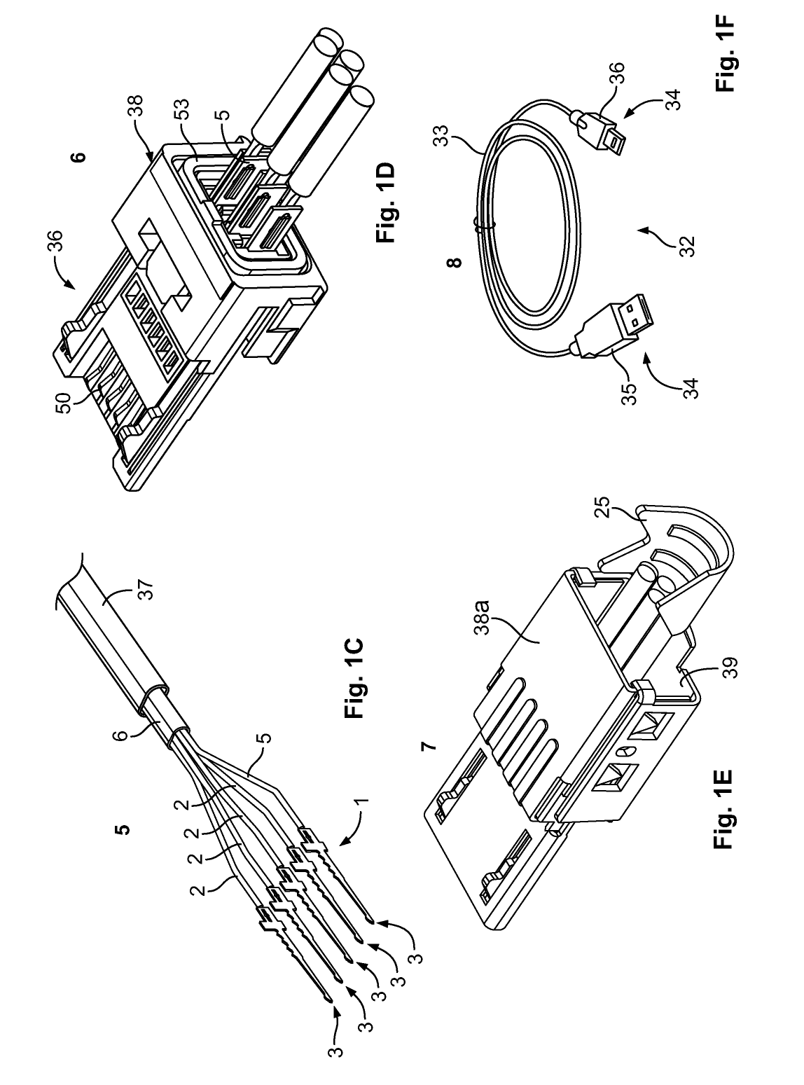

FIG. 1: is a schematic representation of the various stages of the method of manufacturing a cable assembly according to an embodiment of the present invention;

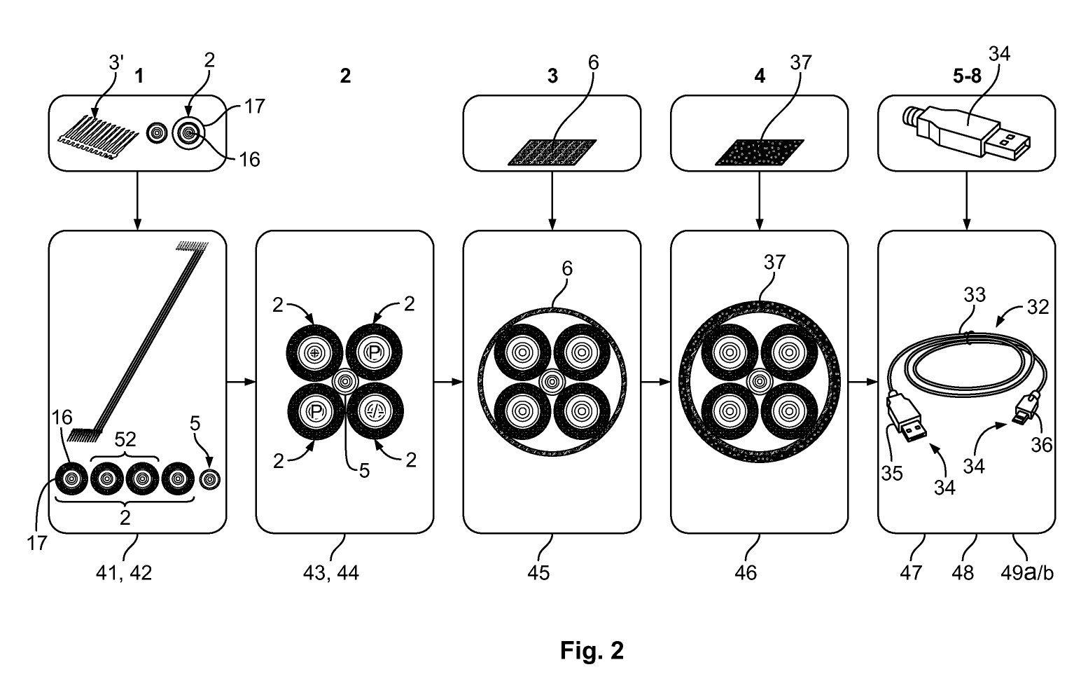

FIG. 2: is a schematic representation of the method of the embodiment shown in FIG. 1, further illustrating the production steps 2 to 4 and demonstrating the materials added during each process step at the cable production process;

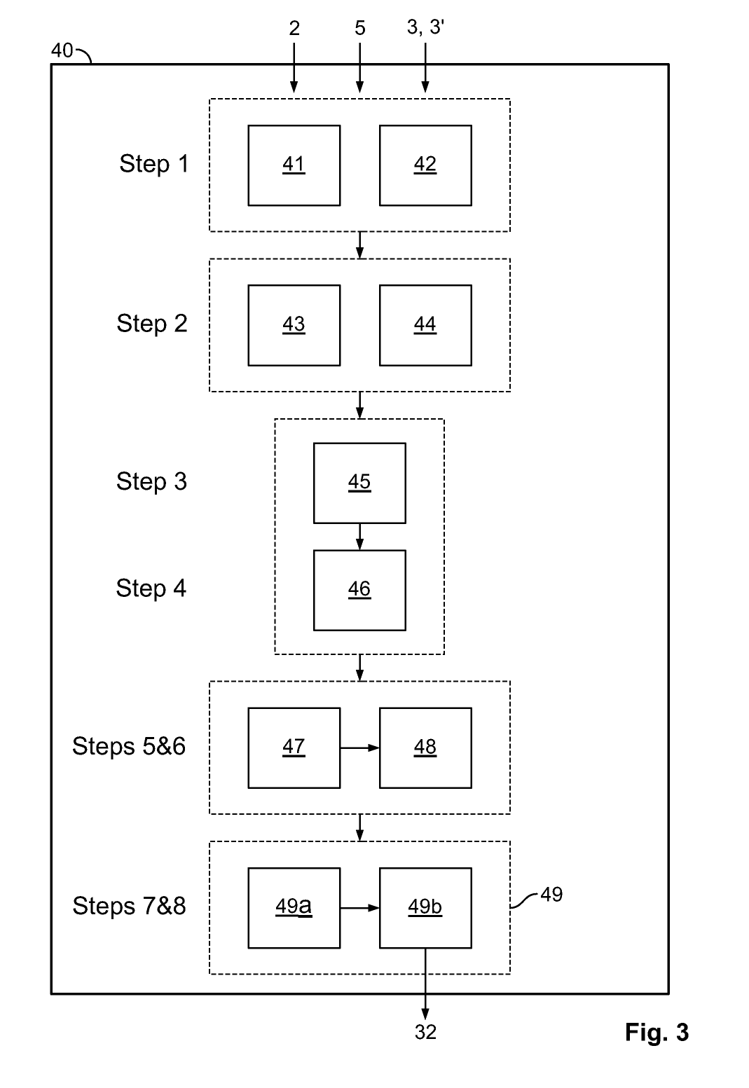

FIG. 3: is a schematic representation of an embodiment of an apparatus for manufacturing a cable assembly according to the present invention;

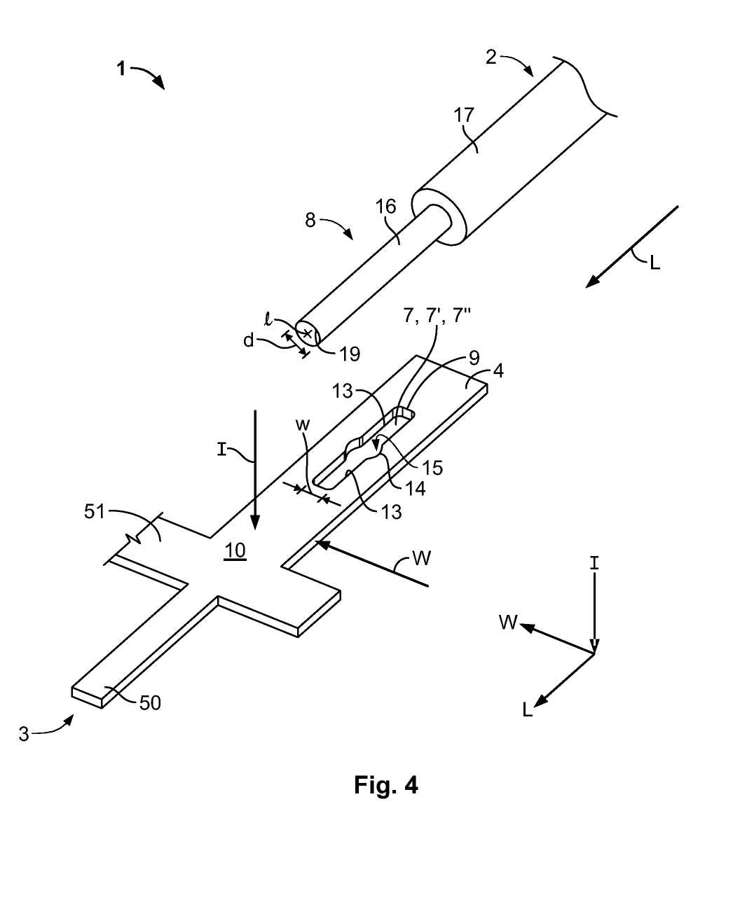

FIG. 4: is a schematic perspective view a terminal assembly, i.e. a cable wire that is electrically and mechanically connected with a terminal element, produced in the step of contacting a cable wire with a terminal element according to a first embodiment in the pre-assembled state;

FIG. 5: is a schematic perspective view of the terminal assembly of FIG. 4 in the assembled state;

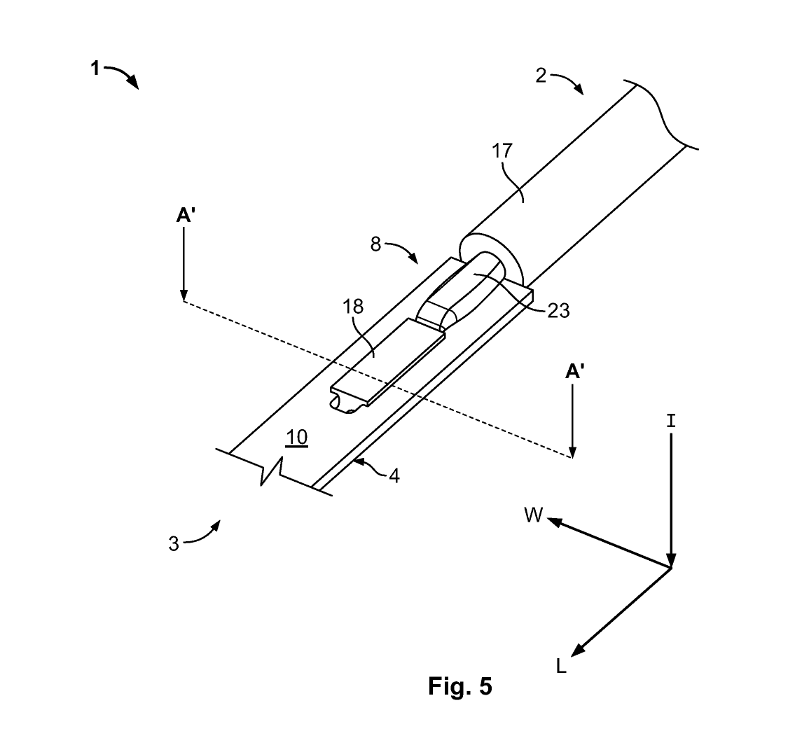

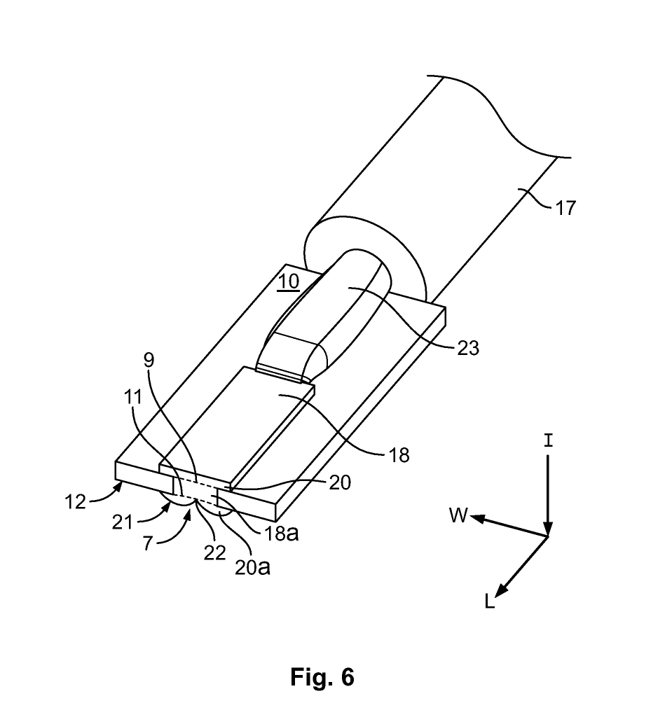

FIG. 6: is a schematic perspective view of section A of FIG. 4 showing the cross-sectional representation at the sectional line A′-A′;

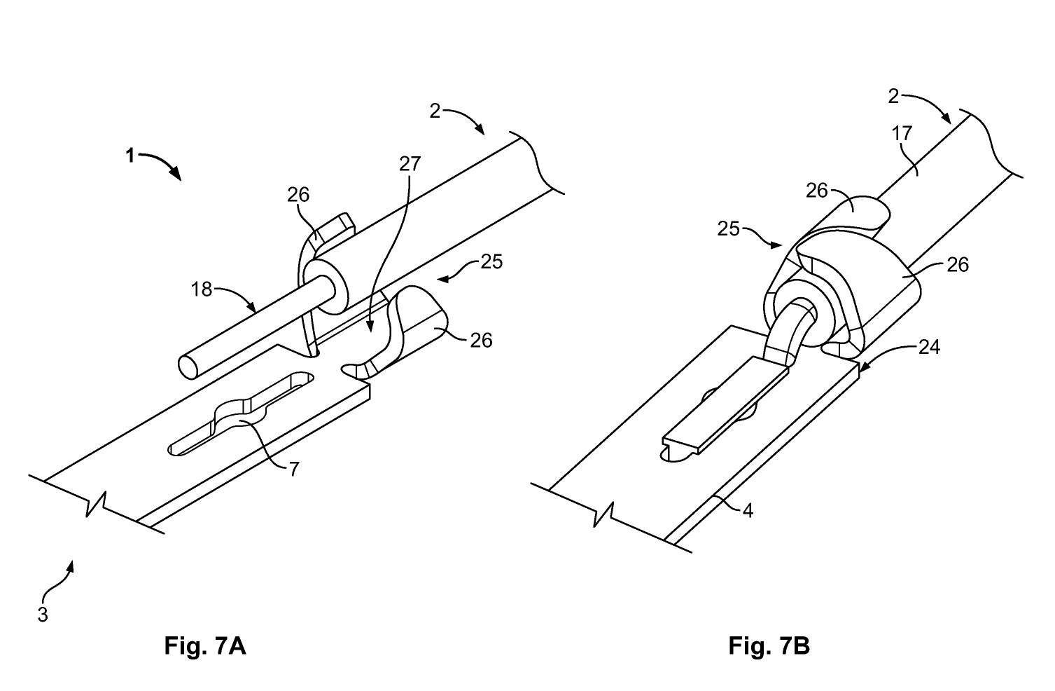

FIGS. 7A and 7B: are schematic perspective views of a terminal assembly according to a second embodiment in the pre-assembled sate (FIG. 7A) and in the assembled state (FIG. 7B);

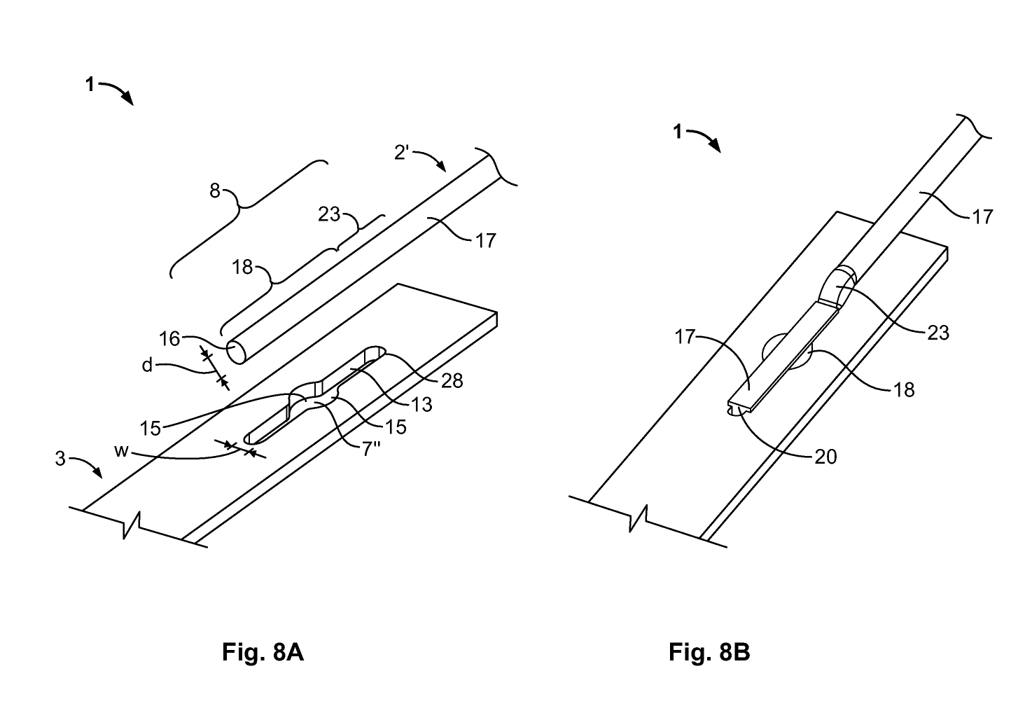

FIGS. 8A and 8B: are schematic perspective views of a terminal assembly according to a third embodiment in the pre-assembled sate (FIG. 8A) and in the assembled state (FIG. 8B);

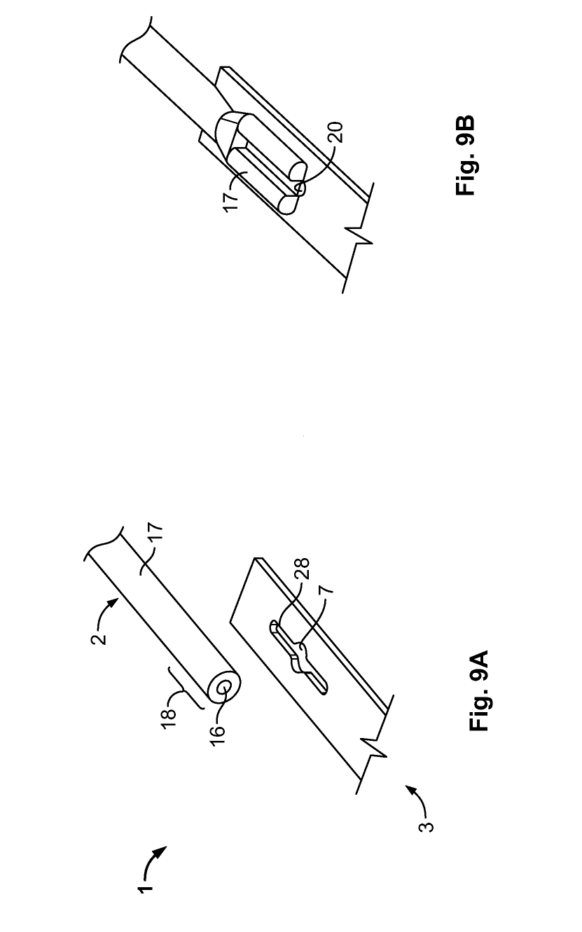

FIGS. 9A and 9B: are schematic perspective views of a terminal assembly according to a fourth embodiment in the pre-assembled sate (FIG. 9A) and in the assembled state (FIG. 9B);

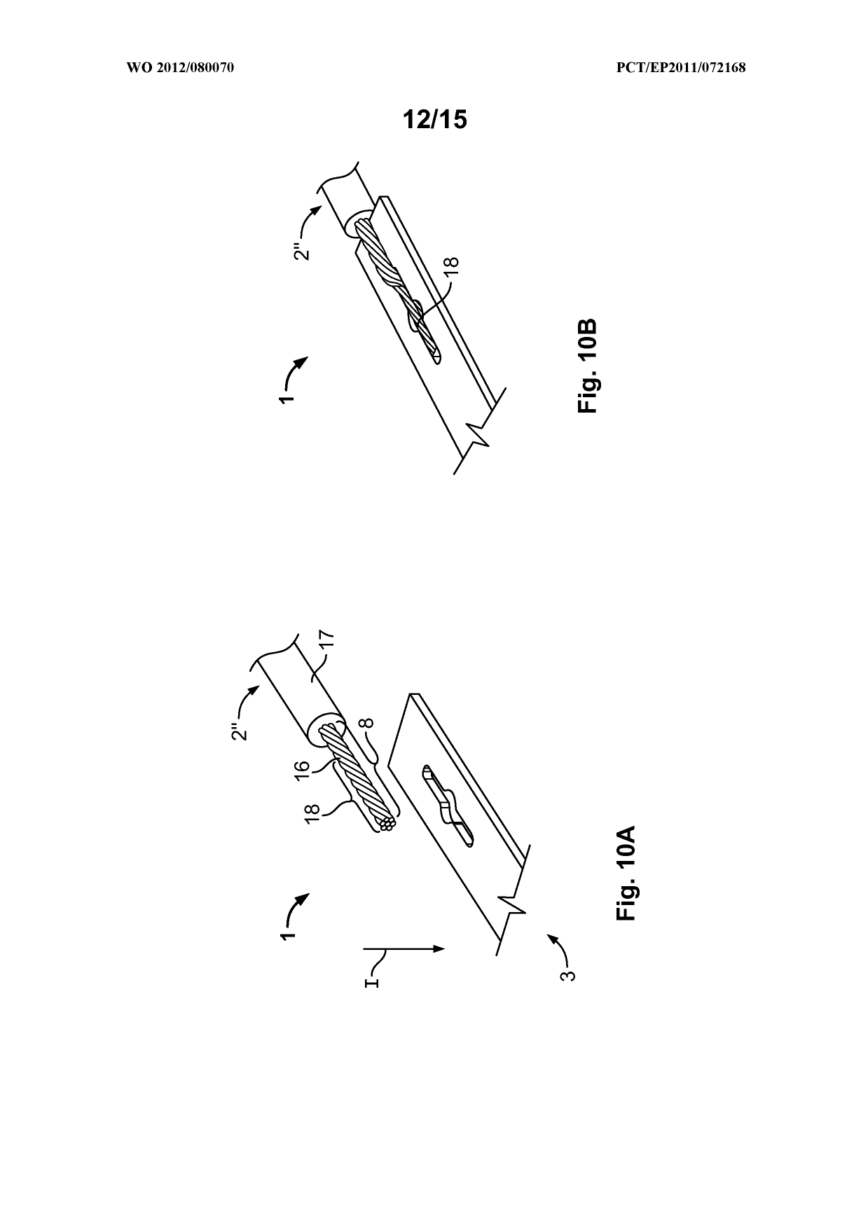

FIGS. 10A and 10B: are schematic perspective views of a terminal assembly according to a fifth embodiment in the pre-assembled state (FIG. 10A) and in the assembled state (FIG. 10B);

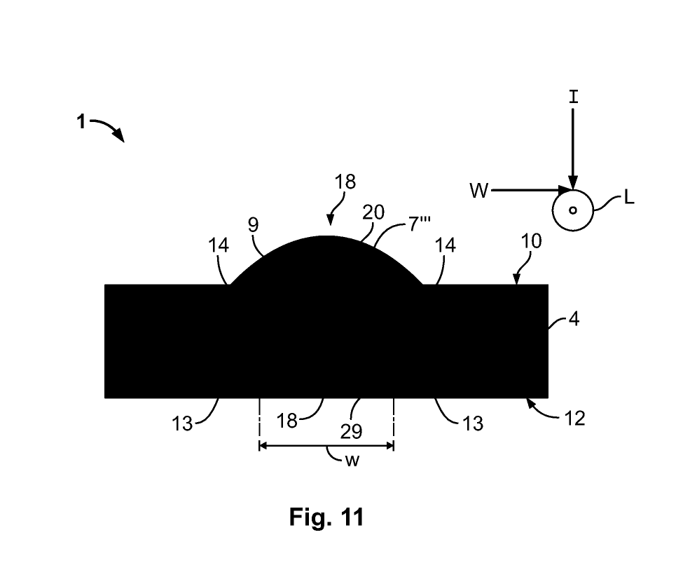

FIG. 11: is a schematic planar view of a valve of a sixth embodiment of the terminal assembly taken along a cross-sectional line corresponding to a cross-sectional line A′-A′ of FIG. 5;

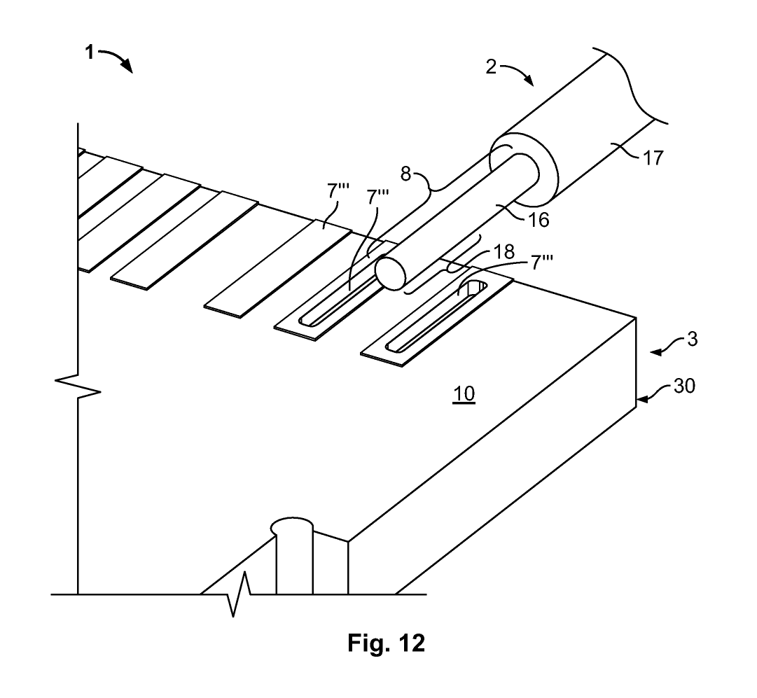

FIG. 12: is a terminal assembly in a seventh embodiment in the pre-assembled state; and

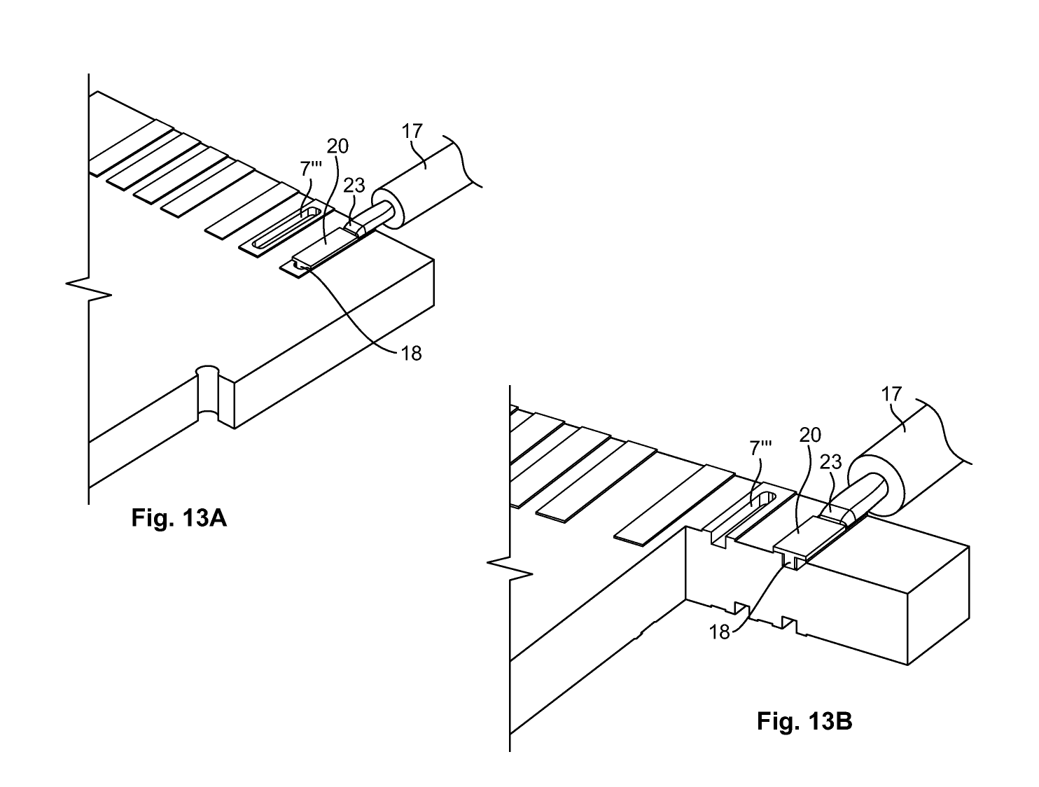

FIGS. 13A and 13B: are schematic perspective views of the terminal assembly of FIG. 12 in the assembled state, wherein in FIG. 13B a part of this terminal assembly is cut off for showing a lateral cut of the terminal assembly corresponding to the cut A′-A′ of FIG. 5.

Hereinafter, the method for manufacturing a cable assembly 32 according to the present invention by example to manufacturing a micro USB-USB cable assembly 32 as well as an apparatus 40 for manufacturing the cable assembly 32, which apparatus 40 is specifically designed for carrying out the manufacturing method depicted in FIGS. 1 and 2, will be described.

The cable assembly 32 comprises a cable 33, having at each end thereof a connector 34. In the shown embodiment, a USB plug connector 35 and a micro USB plug connector 36 are connected to one end of the cable 33, respectively. The method and the apparatus 40 of the present invention a explained in the following by detail to the micro USB-USB cable assembly 32 shown in the Figures only. However, the present invention is not limited to USB cable assemblies 32, but can be used for the manufacture of any cable assembly having at least one connector 34, which may be either a male or female connector on each end of the cable 33.

The embodiment of the manufacturing method that is shown in FIGS. 1 and 2 comprises the following eight process steps:
1. connecting both ends 2a and 2b of the cable wires 2 and the drain wire 5 with the terminal elements 3;
2. bundling the wires 2 and the drain wire 5;
3. providing a foil 6 around the bundled wires 2;
4. providing a braiding (optionally) and cable jacket 37 around the foil 6 surrounding the wires 2;
5. separating the terminal elements 3;
6. placing and securing the terminal elements 3 in the housing 38 of the connector 34;
7. adding the connector shield 38a and the connector crimp 39 to the connector housing 38; and
8. overmolding the connectors 34.

An exemplary apparatus 40 for the manufacture of the cable assembly 32 according to the manufacturing method of FIG. 1 is schematically disclosed in FIG. 3.

The apparatus 40 of FIG. 3 comprises termination unit 41 for connecting the wires 2 (optionally, the drain wire 5) to the terminal elements 3, optionally a twisting unit 42 for twisting at least two cable wires 2 building a twisted cable pair 52, a bundling unit 43 for bundling the cables, a shielding unit 44 for shielding the bundle of wires 2, here for example wrapping the laminated foil 6 around the bundle of cables 2, a braiding unit 45 for braiding the cable 2, a jacketing unit 46 for providing a cable jacket 37 around the cable wires 2, here for example a unit wrapping the jacket 37 around the (laminated) foil 6 or overmolding the jacket 37, a terminal separation unit 47 for separating the terminal elements 3, a terminal insertion unit 48 for placing the terminal elements 3 in the housing 38 of the connector 34, and a connector assembly unit 49 for finishing the assembly of the connectors 34.

In the embodiment of the apparatus 40 that is shown in FIG. 3., the connector assembly unit 49 is composed of an assembly unit 49a capable of placing the shield 38a and the crimp element 39 comprising crimping a crimp barrel 25 around the bundle of cables 2, 5, as well as a molding unit 49b for overmolding the connectors 34. The assembly unit 49 and the molding unit 49b can also be designed as two separate units of the apparatus 40 instead of being combined (indicated by the dotted line) in a connector assembly unit. The same applies to the termination unit 41 and the finishing unit, to the bundling unit 43 and the braiding unit 49, to the shielding unit 45 and the jacketing unit 46 as well as the terminal separation 47 and the terminal insertion unit 48.

In the following, the individual steps of the method of manufacturing a cable assembly 32 according to the shown embodiment will be described with reference to the Figures.

1. Wire Twisting and Termination

In the exemplary embodiment shown in the Figures, a USB cable assembly 32 is depicted that comprises four cable wires 2 including two data wires, a power line and a ground, as well as a drain wire 5, i.e. an additional grounding wire.

In the first method step, cable wires 2 and the drain wire 5 of the cable assembly 32, having a predetermined length L₂, L₅ that is adapted to the length of the preassembled cable assembly 32 to be manufactured are connected with their first end 2a to a first set of terminal elements 3. Each cable wire 2 and the drain wire 5 connected to a terminal element 3 forms a terminal assembly 1.

In the shown embodiment, the terminal elements 3 are part of a terminal array 3′, in the form of a contact frame, wherein a plurality of terminal elements 3 are interconnected substantially parallel with each other and adjacent to one another.

Each of the terminal elements 3 comprises a contact portion 4 having a contact segment 7, to which the respective end 2a of each of the cable wires 2 and the drain wire 5 is mechanically and electrically connected for forming the terminal assemblies 1. On its other end, the terminal element 3 comprises a contact pin 50, which provides the respective contact in the connector 34 of the cable assembly 32. Between the contact portion 4 and the contact pin 50 a carrier 51 is provided that substantially runs perpendicular to the longitudinal direction L of the terminal element 3 and which interconnects the adjacent terminal elements 3 in the terminal array 3′ and arranges the terminal elements 3 in a predefined pattern as shown in the Figures.

After the cable wires 2 and the drain wire 5 have been connected with their one end 2a to the terminal elements 3, the two data wires of the exemplary USB cable assembly 32 are intertwined forming a twisted pair 52, before the other end 2b of the cable wires 2 and the drain wire 5 are connected with another set of terminal elements 3 in a similar way as the other end 2a of the wires 2, 5. Alternatively, a twisted pair may the formed first and thereafter both ends 2a, 2b of the wires 2, 5 is terminated.

The termination can be done for example by crimping or soldering the ends 2a, 2b of the cables 2, 5 to the contact segment 7 of the terminal element 3. Alternatively, the cables 2, 5 can be connected with the contact segment 7 by IDC.

In the following, an exemplary way of mechanically and electrically connecting the cable wire 2 and the drain wire 5 to the terminal elements 3 for building the terminal assemblies 1 that allows for an automation of the termination is shown with reference to FIGS. 4 to 10, resulting in the termination shown from a top and bottom view in the enlarged circle depicted from method step 1 in FIG. 1. In FIGS. 4 to 10, only an extract of the whole terminal array 3′ that shows just one terminal element 3 or just the contact portion 4 of one terminal element 3 is shown.

Each terminal element 3 of the shown embodiment in the terminal array 3′ has generally a pin-like structure having a contact portion 4 and a contact pin 50. Hence, the terminal element according to this embodiment refers to what is generally known as a terminal connector 3. The pin-like contact is however only an exemplary embodiment and any other contact type could likewise be used. In the following embodiment, the terminal element 3 will be referred to as a terminal 3.

The terminal 3 of the embodiment shown in FIG. 4 is made of a material that conducts electricity so that once the wire 2 is joined with the contact portion 4 of the terminal 3, the contact pin 50 is electrically connected to the wire 2.

In the contact portion 4, the contact opening 7 is provided. The contact opening 7 is elongated in the longitudinal direction L of the terminal 3. The wire 2 is principally aligned with the longitudinal direction L of the terminal 3, in which longitudinal direction L the contact opening 7 is also elongated. For mechanically and electrically connecting the electric wire 2 to the terminal 3, at least the connecting portion 8 of the wire 2 is aligned parallel to the entrance surface 9 of the contact opening 7, which entrance surface 9 is arranged at the upper side 10 of the terminal 3. Furthermore, the connecting portion 8 of the wire 2, namely the longitudinal axis 1 of the wire 2 is aligned with the longitudinal direction L of the terminal 3 and the elongated contact opening 7.

In the first embodiment of FIGS. 4 to 6, the contact opening 7 is designed as the through-hole 7′, extending from the entrance surface 9 at the upper side 10 of the contact portion 4 up to the exit surface 11 at the lower side 12 of the contact portion 4. Due to the elongated shape of the contact opening 7, the through-hole 7′ is designed as a slot 7″ extending along the longitudinal direction L. The lateral sides 13 of the slot 7″ are provided with an undercut 14. In the shown embodiment, the undercut 14 is formed as a cavity 15 forming a dent, in which the width w taken along the width direction W of the contact opening 7 and the terminal 3 is widened. Alternatively, the undercut 14 could be designed by protrusions (not shown) extending from the lateral sides 13 of the slot 7″ into the contact opening 7 thereby reducing the width w of the slot 7″ at the position of the undercuts 14.

The wire 2 of the embodiment of FIG. 4 comprises a solid conductor or lead 16 that is covered on the outside with an insulating coating 17 insulating the conductor 16 against the outside.

The connecting portion 8 of the wire 2 is located at one end of the wire 2. In the connecting portion 8, the insulating coating 17 of the wire 2 is removed in the embodiment shown in FIG. 4 so that the blank conductor 16 is exposed and can be mechanically and electrically connected to the contact opening 7, as described in the following by example with reference to the first embodiment of the terminal assembly according to FIGS. 4 to 6.

For mechanically and electrically connecting the wire 2 to the terminal 3, the joining section 18 of the connecting portion 8 is contacted with the contact opening 7. During the contacting step, the joining section 18 is plastically deformed by pressing it into the contact opening 7, in an insertion or press direction I that is substantially perpendicular to the entrance surface 9 and the upper side 10 of the contact portion 4 as well as perpendicular to the longitudinal axis 1 of the aligned wire 2. By pressing in the insertion direction I, the joining section 18 enters through the entrance surface 9 into the contact opening 7. Thereby the lateral cut 19 of the joining section 18 is plastically deformed since the width w of the contact opening 7 of the entrance surface 9 is smaller than the width w the diameter d of the conductor 16. Since the conductor 16 is made from a malleable material, the joining section 18 is force-fitted into the contact opening 7 by contacting the joining section 18 with the contact opening 7. For ensuring a secure non-positive connection between the wire 2 and the contact opening 7, the lead 16 in the joining section 18 has to be provided with sufficient material to allow plastic deformation achieving a non-positive connection due to plastic deformation of the wire 2.

The terminal assembly 1 of the first embodiment in the assembled state is shown in FIGS. 5 and 6. As can be seen in FIG. 5, the joining section 18, that is that part of the connecting portion 8 of the wire 2 that is aligned with the contact opening 17 and is plastically deformed forming the connection between the wire 2 and the terminal 3, substantially fills up the complete slot 7″ that forms a contact opening 7 in the first embodiment. By filling up the complete contact opening 7, the contact area between the deformed joining section 18 and the contact opening 7 is maximized thereby maximizing the force-fit connection between the wire 2 and the contact opening 7.

The contacting step of plastically deforming the joining section 18, in the shown embodiment, the step of pressing the conductor 16 into the contact opening 7 to form the joining section 18 can, for example, be conducted by using a deformation or pressing tool that may be part of the termination unit 41. The pressing tool may comprise a deformation unit (not shown) with a substantially flat surface that presses the connecting portion 8 in the insertion direction I against the contact portion 4 of the terminal 3 having the contact opening 7. The joining section 18 of the wire 2 that is aligned with a contact opening 7 is deformed such that the malleable lead 16 is pressed into the contact opening 7, and through the complete contact opening 7 from its entrance surface 9 to its exit surface 11. After the joining section 18 swells out of the exit surface 11, a counter-deformation unit (not shown) is pressed against the insertion direction I from the lower side 12 of the contact portion 4 against the part of the joining section 18 that swells out of the exit surface 11. By compressing the joining section 18 from the upper side 11 and from the lower side 12, the lateral cut 19 of the joining section 18 is deformed thereby contacting the joining section 18 with the contact opening 7. The part 18a of the joining section 18 that is situated in the contact opening 7 after the contacting step forms the non-positive connection of the wire 2 with the terminal 3 that ensures the mechanical and electrical assembling of the terminal assembly 1. Since the volume of the joining section 18 is greater than the volume of the contact opening 7, a part of the joining section 18 remains outside the contact opening 7 at the upper side 10, which part did not enter the contact opening 7. Another part of the joining section 18 that swelled out of the exit surface 11 is also located outside the contact opening 7 on the lower side 12.

Due to the flat surface of the deformation unit (not shown), pressing the joining section 18 in the insertion direction I from the upper side 10, the portion at the upper side 10 forms a stopper 20 that seals and overlays the entrance surface 9 of the contact opening 7. The stopper 20 on the upper side 10 has the shape of a flat plate and extends, in the width direction W and against the width direction W over the lateral sides 13 of the slot 7′, thereby forming a form-fit connection of the joining section 18, securing the wire 2 in the insertion direction I in the contact opening 7.

A similar stopper 20a is formed at the lower side 12 of the contact portion 4. This stopper 20a overlays the exit surface 11 in a similar manner as the stopper 20 overlayers the entrance surface 9 of the upper side 10. Thus, the stopper 20a secures the joining section 18 in a form-fit manner in the contact opening 7 against in the direction opposite to the insertion direction I.

The only difference between the stopper 20 at the upper side 10 and the stopper 20a at the lower side 12 is that the lower stopper 20a has not a substantially planar shape but is rather formed with two bulges 21 and 21′. One of each bulge 21, 21′ extends over one of the lateral sides 13 at the exit surface 11 of the contact opening 7. The two bulges 21, 21′ meet approximately in the middle of the exit surface 11, so that the stopper 20a at the lower side 12 is provided with a central groove 22. By forming the stopper 20a with two bulges 20, 20′ and a middle channel or groove 22, the secure form-fit can be formed even with a minimum amount of material of the joining section 18 swelling out of the exit surface 11 because less material is required in the channel 22 and nearly all the swelling out material can be deformed and pressed in and against the width direction W forming the two bulges 21 and 21′.

As can be seen in FIG. 5, the remainder of the connecting portion 18 that is not aligned with the contact opening 7 and therefore does not form the joining section 18, is pressed against the upper side 10 of the contact portion 4 of the terminal 3 forming a transition section 23 that is located between the joining section 18 and the remaining wire 2 outside the connecting portion. Since the transitions section 23 is not pressed into the contact opening 7, the transition section 23 is flattened, however, remains higher than the stopper 20 of the joining section 18.

In the following, further embodiments of a terminal assembly 1 that may be formed upon termination the wires 2, 5 to a terminal element are presented. For elements having a similar or identical structure/function as elements of the first embodiment, the same reference signs are used. In the following, only the differences between the further embodiments of the terminal assembly 1 with respect to the first embodiment shown in FIGS. 4 to 6 are described.

The second embodiment of the terminal assembly 1 is shown in FIGS. 7A and 7B. FIG. 7A illustrates the terminal assembly 1 comprising the wire 2 and the terminal element 3 in the pre-assembled state. The assembled state, wherein the wire 2 is contacted to the contact portion 4 of the terminal element 3 can be seen in FIG. 7B.

The terminal assembly 1 of the second embodiment principally corresponds to the terminal assembly 1 of the first embodiment shown in FIGS. 4 to 6.

The only difference is that the contact portion 4 of the second embodiment is at the free end 24, facing away from the contact pin, provided with a crimp barrel 25. The crimp barrel 25 is designed, in the pre-assembled state shown in FIG. 7A, by a pair of crimping pieces 26 arranged in a portion having a substantially U-shaped section. The two crimping pieces 26 form a recess 27, in which the wire 2, having the insulating coating 17 can be introduced when assembling the terminal assembly 1. After insertion of the wire 2 in the recess 27, the crimping pieces 26 are bent with their free ends towards each other embracing and fixing the wire 2 in the recess 27. Alternatively, the crimp banel 25 may be provided on connector crimp 39 that is coupled as part of the connector 34 to the connector housing 38, as disclosed in FIG. 1 for example.

By providing the terminal 3 with a crimping barrel 25, an additional joint can be formed between the wire 2 and the terminal element 3. Said additional joint will take up the main load if someone pulls at the wire 2, thereby reducing the tensions at the connection between the joining section 18 and the opening 7.

FIGS. 8A and 8B illustrate a third embodiment of the terminal assembly 1 having a wire or cable 2 and a terminal element 3. FIG. 8A shows the terminal assembly 1 of the third embodiment in the pre-assembled state. FIG. 8B displays the terminal assembly 1 of the third embodiment in the assembled state, where the wire 2 is mechanically and electrically connected to the terminal element 3.

The terminal element 3 of the third embodiment is identical to the terminal element 3 of the first embodiment shown in FIGS. 4 to 6.

Contrary to the terminal assembly 1 of the first embodiment, the terminal assembly 1 of the third embodiment comprises a magnet wire 2′. The magnet wire 2′ is a wire conductor 16, usually of copper or aluminium, that is covered with a thin insulation 17. The thin insulation 17 of the magnet wire 2′ covers the complete lead 16 so that in the pre-assembled state shown in FIG. 8A, the connecting portion 8 is also provided with an insulating coating 17, contrary to the wire 2 of the first embodiment.

According to the third embodiment of FIGS. 8A and 8B, the insulating coating 17 of the wire 2′ is removed in the joining section 18 during the step of contacting the joining section 18 with the contact opening 7. Since the diameter d of the magnet wire 2′ is larger than the width w of the slot 7′ forming the contact opening 7 of the terminal 3, the insulating coating 17 is removed from the lead 16 in the joining section 18 upon plastically deforming the lateral cut 19 of the joining section 18 when contacting said joining section 18 with the terminal 3.

As can be seen in FIG. 8B, only in those sections of the wire 2′ that are wider than the width w of the slot 7′, the insulation coating 17 is scraped off and thereby removed, allowing an electrical connection between the lead 16 and the terminal 3. At those sections of the magnet wire 2′, that are aligned with the contact opening 7, and do not extend beyond the lateral sides 13 of the slot 7′, the insulation 17 remain in place as in these sections, the insulation 17 is not scraped of at the edge 28 of the entrance 9. Therefore, the joining section 18 is still isolated at the stoppers 20 and 20a exposed at the upper side 10 and the lower side 12 of the terminal 3.

Finally, it can be seen in FIG. 8B that the joining section 18, upon filing up the contact opening 7, also fills up the cavities 15 provided at those lateral sides 13 of the slots 7″. Thereby, a further form-fit is provided between the joining section 18 and the undercut 14 in the contact opening 7 which secures the joining section 18 against transition of the joining section 18 in and against the longitudinal direction L in the contact opening 7.

The fourth embodiment of the terminal assembly 1, that is shown in FIGS. 9A (pre-assembled state) and 9B (assembled state) comprises a terminal element 3 that is principally identical to the terminal element 3 of FIGS. 1 and 8. The wire 2 of the terminal assembly 1 is a solid wire 2 similar to the wire 2 of the first embodiment. However, contrary to the first embodiment, the insulating coating 17 of the wire 2 in the fourth embodiment extends onto the connecting portion 8 and principally covers the complete lead 16.

Similar to an insulation displacement connector, the terminal 3 of the fourth embodiment of FIGS. 9A and 9B removes the insulation coating 17 in the joining section 18 of the wire 2 upon connecting said joining section 18 with the contact opening 7 of the contact portion 4 of the terminal 3. The edge 28 surrounding the entrance surface 9 at the upper side 10 of the contact portion 4 functions, upon pressing the wire 2 in the insertion direction I against the terminal 3, as a blade that removes the insulation coating 17 in the joining section 18 so that only the lead 16 of the joining section 18 is pressed into the contact opening 7.

In embodiments having a wire 2 that is provided with an insulating coating 17 in the connecting portion 8, a terminal element 3 having a contact opening that is provided with an undercut 14, such as the cavities 15 shown in FIG. 8A, has the additional benefit of keeping the insulation at the upper side 10 of the terminal 3 connoted with the cutted insulation at the lower side 12. This avoids pollution in the deformation or pressing tool due to release of the cut insulation into the tool. Further, the insulation remains for the wire 2 on both sides 10 and 12 of the terminal element 3 even in the joining section 18, where the electrical contact is made between the joining section 18 and the contact opening 7.

FIGS. 10A and 10B show a fifth embodiment of a terminal assembly 1, wherein the pre-assembled state is shown in FIG. 10A and FIG. 10B depicts the assembled state.

The terminal element 3 of the fifth embodiment is principally identical to the terminal element 3 of the first embodiment of FIGS. 1 and 4. Furthermore, the wire 2″ of the fifth embodiment principally corresponds to the wire 2 of the first embodiment, wherein insulating coating 17 is removed in the connecting portion 8 so that a blank lead 16 is exposed to the outside.

In contrast to the wire 2 of the first embodiment, the wire 2″ of the fifth embodiment is a stranded wire 2″ that is composed of a bundle of smaller wires making up the conductor.

The termination and the twisting of cable wires can be performed in an apparatus 40 either comprising two separate units, a termination unit 41 and a twisting unit 42, or having a combined termination and twisting unit as indicated with the dashed line in FIG. 3

2. Bundling the Wires

In the second step of the exemplary method of manufacturing a cable assembly 32, shown in FIGS. 1 and 2, the four cable wires 2 and the drain wire 5 are bundled such that the cable wires 2 are arranged principally around the drain wire 5 that is placed in the centre, as can best be seen in the cross-sectional illustrated in FIG. 2. Alternatively, the drain wire 5 could be replaced by a central strength member or filler.

For bundling the wires 2 and the drain wire 5, the apertures 40 may comprise a bundling unit 43 for combining and intertwining the individual wires 2, 5.

3. Shielding

In the next process step, the bundled cables 2, 5 are surrounded by an outer shielding enclosing the bundle of cables 2, 5. In the shown embodiment, a laminated foil 6 composed of an isolating foil onto which a conductive layer is laminated, is wrapped around the bundle of cables 2, 5 for providing the outer shielding. Alternatively, the laminated foil 6 could be replaced by a normal aluminium shielding or Mylar tape.

For providing the shielding, here the laminated foil 6, the shielding unit 45 may comprise a wrapping unit for wrapping the laminated foil 6 around the bundle of cables 2, 5

Even though only an outer shielding wrapped around all of the cable wires 2 and the drain wire 5 is depicted in the exemplary embodiment of FIGS. 1 and 2, an inner shielding enclosing only part of the cable wires 2, e.g. the twisted pair 52 could alternatively or additionally be provided.

4. Providing the Cable Jacket

The manufacture of the cable that is performed during the inventive method of manufacturing a cable assembly 32 is finished in the fourth method step of the exemplary method shown in FIGS. 1 and 2. In the fourth step, a cable jacket 37 is manufactured in a predetermined length L₃₇ that is adapted to the length of the cable wires 2 around the cable wires 2 running inside the outer shielding formed by the laminated foil 6. The jacket 37 may be manufactured and provided in the predetermined length L₃₇ by wrapping the jacket material around the laminated foil 6. Alternatively, the jacketing unit 46 could be provided with a cutting device cutting the jacket material on the correct length or with molding means for overmolding the cable jacket 37 in the predetermined length L₃₇. Since the jacket 37 is manufactured precisely in the predetermined length L₃₇ waste material resulting from a removal of jacket material, as necessary in the production of known cable assemblies, does not occur. Further the risk of damaging the cable wires 2 during the removal of the jacket is avoided and the cable jacket 37 of the preassembled cable assembly 32 according to the present invention has smooth edge, contrary the the sharp cutting edges resulting from the deisolation of a cable jacket as performed in the known production processes.

After the fourth step of the exemplary method of manufacturing a cable assembly 32 shown in FIGS. 1 and 2, an assembling state is achieved which, in the common methods of the prior art would be achieved after the excessive work of producing a cable first, thereafter preparing the cable by stripping the isolation and the shielding, separating the individual cables, arranging the cables in the desired, individual arrangement and then terminating both ends of each wire to the corresponding terminal element. Most of this excessive work becomes redundant by the method according to the present invention, according to which the cable wires 2 are connected with the terminal elements 3 first and thereafter the cable 33 is built by at least providing a jacket 37 around the cable wires 2. Hence, the number of steps of manufacturing a cable assembly 32 is minimized since the steps of cable preparation that must be performed according to the methods known from the prior art become redundant.

5. Separating the Terminal Elements

In the fifth step of the exemplary method of manufacturing a cable assembly 32 shown in FIG. 1., the individual terminal elements 3 of the five terminal assemblies 1, namely the four cables wires 2 connected to a terminal element 3 of the terminal assembly 3′, and the drain wire 5 connected to a further terminal assembly 3, are separated from each other and from the remainder of the terminal array 3′.

For separation, the connection strip or contact carrier strip 51 is cut between the adjacent terminal elements 3, which may be performed in a terminal separation unit 47 having a cutting or separation means for cutting the connection strip or carrier strip 51 at the corresponding position.

6. Placing and Securing the Terminal Elements in the Housing of the Connector

In the sixth method step, the individualised terminal assemblies 1, namely their terminal elements 3 are placed at their predetermined positions in the connector housing 38, in the shown embodiment a housing 38 for a micro USB-connector 36. Once all the terminal elements 3 are arranged in the predetermined position in the connector housing 38, the terminal elements 3 are secured in the housing 38 by means of a locking spring 53. Alternatively terminal elements could be secured in the housing by over molding the terminal springs. In that case terminal springs will be pre-positioned by equipment.

The micro USB-connector 36 shown in FIG. 1 is of course only an exemplary embodiment and the terminal elements could be placed in each other type of connector 34 regardless of the connector being a male or a female connector.

Even though the terminal separation unit 47 and the terminal insertion unit 48 are described as separate units in the shown embodiment, of course a combined unit 48, 47 could be likewise used having means for performing both, the cutting of the connection strip 51 and the separation of the terminal elements 3 as well placing the terminal elements 3 in the connector housing 38 and securing the terminal elements 3 in the housing 38 by means of a locking spring 53 or over molding.

7. Adding Connector Shield and Connector Crimp

In the seventh step of the exemplary method of manufacturing a cable assembly 32, a connector shield 38a is connected with the housing 38 such that the assembly of connector housing 38 and connector 38a encompass the contact pins 50 of the terminal elements 30.

Further, a connector crimp 39 is attached to that side of the connector housing 38 that is opposite to the side, to which the connector shield 38a is attached. The connector crimp 39 comprises a crimp barrel 25 that is arranged at that end of the connector housing 38 at which the terminal elements 3 enter the housing and is positioned such that the crimp barrel 25 may be crimped around the cable wires 2 shortly before the wires 2 are terminated with a terminal element 3.

8. Overmolding the Connectors

In the final step of the method according to the exemplary embodiment shown in FIG. 1, the connectors 34 are overmolded in a molding unit 49b for finishing the manufacture of the cable assembly 32.

In the embodiment of a method of manufacturing a cable assembly 32 shown in FIGS. 1 and 2, a micro USB-cable assembly 32 is shown by way of example having terminal connectors with a contact pin 50.

But the method and the process of the present invention is not limited to manufacturing a cable assembly 32 having terminal contact pins 50, but rather can be used for produced any type of cable assembly having at least one connector 34 at each end of the cable 33. For example, connectors having printed circuit boards as a terminal element 3 can be used.

By way of example, in the FIGS. 12 and 13, an alternative method step for connecting the cable wires 2 with a terminal element 3 that is composed of a printed circuit board (PCB) 30, is shown.

The wire 2 is generally the same as the wire 2 used in the embodiment of FIGS. 4 to 6, namely a solid wire 2 having an insulating coating 17 that is removed in the connecting portion 8, where the conductor 16 is exposed to the outside.

The terminal element 3 designed as a printed circuit board 30 has arranged on contact side 31 thereof, a series of spaced apart contact openings 7. As can be seen, for example, in FIG. 10B, the contact opening 7 of the PCB 30 is designed as contact channel 7′″.

Upon contacting the connecting portion 8 of the wire 2 to the contact opening 7 of the PCB 30, the joining section 18 is pressed into the contact opening 7 forming a force-fit connection with the contact opening 7. The joining section 18 is filling up the complete channel 7 and the excess portion of the joining section 18 that remains outside the opening 7 is flattened into a stopper 20, whose shape principally corresponds to the stopper 20 located at the upper side 10, as shown in FIGS. 1 and 4 for example.

Finally, FIG. 11 shows a further embodiment for providing a terminal assembly 1 in the method step of connecting a cable wire 2 with a terminal element 3.

FIG. 11 is a schematic representation of a cross-sectional view in the width direction w at a position corresponding to the sectional line A′-A′ of FIG. 5, through the contact opening 7 of a terminal assembly 1 in the assembled state. As can be seen in FIG. 11, the contact opening 7 in the contact portion 4 of the terminal 3 differs from the contact opening 7 of the embodiments shown in FIGS. 4 to 10 in that it is not designed as a through-hole 7′. Rather, the contact opening 7 of the embodiment shown in FIG. 11 is designed as a contact groove or a contact channel 7′″ that can be only entered via the entrance surface 9, exposed at the upper side 10 of the contact portion 4. The shape of the entrance surface 9 may be similar to the shape of the entrance 9 in the previous embodiments and can be designed elongated.

Starting from the entrance surface 9, the width w of the contact channel 7′″ from one lateral side 13 to the other lateral side 13, increases up to the bottom 29 of the channel 7′″. That is, the channel 7′″ principally has a shape of a dovetail, as can be seen in FIG. 11. The lateral sides 13 of the contact channel 7′″ are inclined with respect to the plane defined by the insertion direction I and the longitudinal direction L. Upon filling up the contact channel 7′″ with the joining section 18 of the wire 2, the undercut 14 formed by the inclined lateral walls 13 forms a form-fit connection with the joining section 18 securing the part of the joining section 18 that is located in the contact channel 7′″ against removal out of the channel 7′″ against the insertion direction I.

Furthermore, the stopper 20 on the upper side 10 of the contact portion 4 that overlayers the entrance surface 9 is formed with a curved surface having, in the cross-sectional view, the form of a rivet head, rather than a flat, plate-like shape as in the embodiment of FIG. 4.

In the exemplary embodiment of the manufacturing method and manufacturing apparatus 40 of the present invention that is shown in the Figures, the connectors 34 are assembled in steps five to eight. It is, however, also possible to terminate the wires 2, 5 in the first step to the terminal elements of an already assembled connector. Furthermore, the sequence of the above described steps 5 to 8 of the exemplary embodiment of the manufacturing method according the present invention can be changed, depending on the product lay-out. For example, the separation of the terminal elements 3 of above exemplary step 5 could be done after connecting one end 2a of the cables 2, 5 with terminal elements 3 and before forming a twisted pair 52.

Further, one or more of the above steps 1 to 8 may be combined in a single process step, when appropriate.

The apparatus 40 according the present invention may furthermore comprise a testing unit or test equipment for controlling the correct assembly, as well as a packaging unit for packing one or more preassembled cable assemblies that have been produced by the method of the present invention.

1-15. (canceled)

16. Method of manufacturing a cable assembly comprising the steps of connecting at least one end of cable wires with terminal elements, and thereafter providing a cable jacket around the cable wires.

17. Method of claim 16, wherein both ends of the cable wires are connected with terminal elements before providing the cable jacket.

18. Method of claim 16, wherein the cable wires are bundled, twisted, braided and/or shielded before providing the jacket.

19. Method of claim 18, wherein by providing a foil, preferably a laminated foil around the cable wires for bundling and shielding the cable wires.

20. Method of claim 18, wherein at least two of the cable wires are twisted before connecting both ends of the twisted wires with the terminal elements.

21. Method of claim 16, wherein by connecting at least one end, preferable both ends of the cable wires with a terminal array having a plurality of terminal elements.

22. Method of claim 21, wherein the terminal array comprises a plurality of interconnected terminal elements at least those of which, that have been connected with a cable wire, are separated from each other and from the remainder of the terminal array, preferably after the jacket was provided.

23. Method of claim 16, wherein the end of the cables is connected with the terminal element by crimping or welding or soldering or an insulation-displacement connection; or at least one, preferable all cable wires are connected to a terminal element by: arranging a connecting portion of the wire substantially parallel to an entrance surface of a contact opening of the terminal element; and contacting a joining section of the connecting portion with the contact opening by plastically deforming a lateral cut of the joining section.

24. Method of claim 23, wherein the contact opening is elongated, whereby the connecting portion of the electric wire is arranged substantially parallel to the longitudinal direction of the contact opening.

25. Method of claim 23, wherein the joining section substantially fills up the contact opening during the contacting.

26. Method of claim 23, wherein during contacting, the joining section outside the contact opening is overlaying the entrance surface.

27. Method of claim 23, wherein for contacting, the joining section is pressed into the contact opening in an insertion direction that runs substantially perpendicular to the entrance surface of the contact opening.

28. Method of claim 23, wherein an insulating coating of the wire is removed in the joining section during contacting the joining section with the contact opening.

29. Apparatus for the manufacture of a cable assembly, comprising a termination unit for connecting an end of a cable wire with a terminal element and a jacketing unit for providing a cable jacket around cable wires.

30. Preassembled cable assembly comprising a cable having at least two cable wires running inside a cable jacket, and at least one connector arranged at each end of the cable, characterized in that the cable jacket is manufactured in a predetermined length around the cable wires.
